(19) United States
(12) Patent Application Publication
(10) Pub. No.: US 2019/0170204 A1
(43) Pub. Date: Jun. 6, 2019

(54) ROTATION DAMPER

(71) Applicant: ILLINOIS TOOL WORKS INC., GLENVIEW, IL (US)

(72) Inventors: Stefan E. FUCHS, Gaukönigshofen (DE); Ralph OPITZ, Sulzdorf (DE)

(21) Appl. No.: 16/208,756

(22) Filed: Dec. 4, 2018

(30) Foreign Application Priority Data
Dec. 6, 2017 (DE) 10 2017 128 977.1

(51) Int. Cl. F16F 7/06; F16F 9/12

(52) U.S. Cl. CPC F16F 7/06; F16F 9/12; F16D 2125/48; E05Y 2201/21; E05Y 2201/254; B60G 2202/22

(57) ABSTRACT

A rotation damper for damping movement of a component includes a transmission element couplable to the component such that the transmission element is rotated during movement of the component, and including a rotatingly mounted rotor and also braking device which brakes a rotational movement of the rotor. A coupler couples the transmission element and the rotor for conjoint rotation in a first direction of rotation and decouples the same in a second, opposite direction of rotation. The coupler includes a support element on with an engagement element that is pivotable between an engagement position and a release position. The engagement element has at least one coupling portion, and the transmission element has at least one coupling portion which is in engagement with the at least one coupling portion of the engagement element. The coupling portions are formed in a complementary manner with respect to each other.

### TECHNICAL FIELD

The invention relates to a rotation damper for damping the movement of a component, including a transmission element which is couplable to the component in such a manner that said transmission element is rotated during a movement of the component, and including a rotatingly mounted rotor and also braking means which brake a rotational movement of the rotor, furthermore including coupling means which couple the transmission element and the rotor for conjoint rotation in a first direction of rotation of the transmission element and decouple same in a second, opposed direction of rotation, wherein the coupling means includes a support element on which at least one engagement element is mounted so as to be pivotable between an engagement position, in which the at least one engagement element is in engagement with an engagement structure of the rotor, the engagement structure being arranged radially on the outer side with respect to the at least one engagement element, and a release position, in which the at least one engagement element is not in engagement with the engagement structure of the rotor.

### BACKGROUND

Rotation dampers are used, for example, for damping the pivoting movement of flaps arranged in the interior of a vehicle. Rotation dampers of this type have a rotor which rotates in a viscous liquid, for example an oil or silicone, as a result of which a braking action is produced. The rotation of the rotor is brought about by the pivoting movement of the flap, as a result of which the latter is damped.

In some applications, there is the desire to design the rotation damper with a freewheel in one direction of rotation. The movement of the component to be damped is then only transmitted in one direction of rotation into rotation of the rotor in the viscous liquid. In the opposed direction of rotation, the component is decoupled from the rotor, and therefore the movement of the component in this direction of rotation is undamped and is possible with little effort. For example, an opening movement of a flap can thus be damped, whereas the closing movement of the flap can take place without a braking action of the rotor and therefore damping.

A rotation damper with a freewheel is known, for example, from EP 1 344 958 B 1. In this case, a brake rotor is mounted rotatably in a first housing, wherein the housing or the brake rotor interacts with a pinion which, for its part, interacts with a rack or a gearwheel or the like. Apart from a torque, a linear force component also acts on the pinion during rotation, said force component producing a form fit with the brake rotor in one direction and removing said form fit in a second direction. The form fit leads to transmission of the rotational movement of a component to be damped to the brake rotor and therefore to damping, while the rotation damper freewheels when the form fit is removed.

Further rotational dampers with a freewheel are known from DE 10 2011 113 617 A1 or WO 2016/120835 A1. In the case of the rotation damper known from WO 2016/120835 A1, a rotatable element which is connectable to a component to be damped has a plurality of actuating cams which are accommodated in receptacles of a plurality of radial blocks mounted pivotably on a support disk. Rotation of the rotatable element in a first direction of rotation leads to pivoting of the radial blocks in such a manner that an external toothing of the blocks comes into engagement with an internal toothing of a rotor of the rotation damper. Rotation of the rotatable element in an opposed direction of rotation leads to pivoting of the radial blocks in such a manner that the toothings are disengaged. A freewheel is in turn realized in this manner.

Known rotation dampers with a freewheel sometimes also require a not inconsiderable torque in the freewheeling direction, which may be undesirable depending on the application. In addition, an undesirable movement play is sometimes required for realizing the freewheeling function. In particular, said movement play can lead to an undesirable production of noise. The rotation damper with a freewheel that is known from WO 2016/120835 A1 furthermore requires complicated guide measures as a result of the design for the radial blocks, in particular stop pins. This increases the structural outlay.

### SUMMARY

Starting from the explained prior art, the invention is based on the object of providing a rotation damper of the type mentioned at the beginning which, in a structurally simple manner, permits reliable freewheeling with minimized production of noise.

For a rotation damper of the type mentioned at the beginning, the invention achieves the object in that the at least one engagement element has at least one coupling portion, and in that the transmission element has at least one coupling portion which is in engagement with the at least one coupling portion of the engagement element, wherein the coupling portions of the transmission element and of the at least one engagement element are formed in a complementary manner with respect to each other.

The rotation damper according to the invention serves for damping the movement of a component mounted movably in a vehicle, such as a passenger vehicle or truck, for example a pivotably mounted component, such as a pivotably mounted flap, for example a glove compartment flap or the like. The rotor rotates, for example, in a viscous liquid, as a result of which a braking action is produced. In a first direction of rotation of the component and therefore of the transmission element, the rotational movement is transmitted to the rotor, and therefore a braking action and thus damping of the component movement occur. By contrast, in the opposed direction of rotation, decoupling occurs between the transmission element and the rotor, and therefore a rotational movement of the component and thus of the transmission element does not lead to a rotational movement of the rotor and therefore to damping. Consequently, there is a freewheel in this direction of rotation.

For the coupling of the transmission element and the rotor for conjoint rotation in the first direction of rotation and for the decoupling of same in the second, opposed direction of rotation, the rotation damper according to the invention has coupling means. The coupling means comprise a support element on which at least one engagement element is mounted so as to be pivotable between an engagement position and a release position. In the engagement position, the at least one engagement element is in engagement with an engagement structure of the rotor, the engagement structure being arranged radially on the outer side with respect to the at least one engagement element. In the release position, the at least one engagement element is, by contrast, not in engagement with the engagement structure. The pivot axis of the at least one engagement element is at a fixed distance from the axis of rotation of the rotor and of the transmission element. The axis of rotation of the rotor is arranged in particular coaxially with respect to the axis of rotation of the transmission element. The support element is rotatable in relation to the rotor. It is rotated at the same time as rotation of the transmission element. For this purpose, the support element and the transmission element can be coupled to each other for conjoint rotation, for example by means of a form-fitting coupling. For example, the simultaneous rotation of the support element can be transmitted by the at least one engagement element which is mounted pivotably on the support element. A rotational movement of the transmission element transmitted to the at least one engagement element by the coupling portions thus also leads to rotation of the support element.

The at least one engagement element of the rotation damper according to the invention has at least one coupling portion, and the transmission element has at least one coupling portion which is in engagement with the at least one coupling portion of the engagement element, wherein the coupling portions of the transmission element and of the at least one engagement element are formed in a complementary manner with respect to each other. According to the invention, the coupling portions are therefore in engagement with each other substantially without movement play. For this purpose, their contact surfaces which are in contact with each other are of complementary design. The coupling portions thus transmit a rotational movement of the transmission element to the at least one engagement element which is thereby correspondingly pivoted on the support element between the engagement position and the release position. The directions of rotation of transmission element and engagement element are opposed here. In the engagement position, the at least one engagement element engages in the engagement structure of the rotor in such a manner that a pivoting movement of the at least one engagement element, which pivoting movement is brought about by rotation of the transmission element, is transferred into a rotational movement of the rotor. The direction of rotation of the rotor here is in the same direction as the direction of rotation of the transmission element. By contrast, in the release position, said engagement between engagement element and engagement structure does not exist, and therefore the at least one engagement element and therefore the transmission element can rotate in freewheeling form without rotation of the rotor and damping associated therewith occurring. The engagement position is defined in particular by the engagement of the engagement element in the engagement structure of the rotor. Said engagement limits a further pivoting movement of the engagement element. In the opposed pivoting direction, the release position can be defined by a stop of the engagement element against the transmission element. Said stop prevents a further pivoting movement of the engagement element in said pivoting direction. The coupling portions here are configured according to the invention in a complementary manner in particular such that a rotational movement of the transmission element between the two end positions (release position and engagement position) of the at least one engagement element is always transferred into a pivoting movement of the at least one engagement element. The complementary coupling portions are in engagement with each other in the manner of gears, like the teeth of a gear drive. There is therefore a gear-like, preferably planetary-gear-like coupling between the transmission element and the at least one engagement element. According to the invention, a movement play of the components to be coupled to each other or to be decoupled from each other can be substantially completely omitted. The production of noise is minimized. At the same time, friction losses are minimized, and therefore the torque required for the rotation in the freewheeling direction is likewise minimized. On account of the complementary configuration of the coupling portions, complicated additional guide measures for the at least one engagement element are likewise not required. Finally, the freewheeling system according to the invention can be integrated even into small rotation dampers.

According to one refinement, it can be provided that the at least one coupling portion of the at least one engagement element is at least one circular coupling projection, and that the at least one coupling portion of the transmission element is at least one circular coupling receptacle which is complementary to the at least one circular coupling projection. The circular shapes or the walls of coupling projection and coupling receptacle correspondingly running along a circular path have a substantially identical radius here. The complementary configuration of the circular coupling portions here is realized in particular in such a manner that, during rotation of the transmission element, the at least one coupling portion of the at least one engagement element rolls along the at least one coupling portion of the transmission element by pivoting of the at least one engagement element. By means of this configuration, a particularly secure and low-friction and also low-noise coupling is achieved. It goes without saying that in particular the at least one coupling receptacle does not have a closed circular shape. The at least one circular coupling receptacle can thus be, for example, of C-shaped design. The at least one coupling projection has a complementary shape. The at least one coupling projection and/or the at least one coupling receptacle can extend here in the axial direction of the rotation damper. The at least one coupling projection and/or the at least one coupling receptacle can thus correspondingly have a circular-cylindrical shape.

According to a further refinement, the at least one engagement element can have at least one clamping arm, the free end of which is in engagement with at least one clamping projection of the rotor in the engagement position. The clamping arm carries out a radial movement over the course of the pivoting of the at least one engagement element and, in the process, comes into or out of engagement with the at least one clamping projection of the rotor. The rotor here can have in particular a plurality of clamping projections. The clamping projections can form a toothing in which the free end of the clamping arm of the engagement element or the engagement elements engages in the engagement position. The clamping arm can basically also have a plurality of clamping projections which, for example, can likewise form a toothing. By means of the abovementioned refinement, particularly secure engagement in the engagement position is realized.

According to a further refinement, the at least one engagement element can be in engagement in a force-fitting manner with the engagement structure of the rotor in the engagement position. A particularly reliable transmission of the torque is thereby achieved. In addition to the force fit, there can be a form fit and/or a frictional fit.

According to a further refinement, at least three engagement elements can be provided, wherein the transmission element has at least three coupling portions. Each engagement element has at least one coupling portion. The transmission element then has a corresponding number of coupling portions, i.e. at least three coupling portions which are in engagement with the coupling portions of the engagement element. The coupling portions can each be configured as basically explained above.

According to a further refinement in this regard, it can be provided that the transmission element has a transmission portion on the circumference of which the at least three coupling portions are formed, wherein the at least three engagement elements with their coupling portions are arranged distributed uniformly over the circumference of the transmission portion. The effect of a planetary gear is thereby realized. Particularly good guidance and reliable and low-wear and low-noise transmission of torque are achieved.

The braking means can comprise a housing which is filled with a viscous liquid, for example silicone or an oil and in which the rotor is rotatably arranged. The rotation of the rotor in the viscous liquid produces a braking action which, in turn, damps the movement of the component.

According to a further refinement, the support element which pivotably supports the at least one engagement element can be a support disk which is rotatable relative to the rotor. According to a further refinement in this regard, at least one rotary shaft for the rotatable mounting of the at least one engagement element can be integrally formed on the support disk. The at least one engagement element can have a, for example, cylindrical receptacle with which the at least one engagement element is mounted on the at least one rotary shaft. Reliable and structurally simple mounting of the at least one engagement element is therefore achieved.

According to a further refinement, it can be provided that the at least one engagement element has a basic portion composed of a first material and an engagement portion which is in engagement with the engagement structure of the rotor in the engagement position and is composed of a second material which is softer than the first material. The at least one engagement element can be produced, for example, in a two-component injection molding process. However, it can also consist of two separately produced, interconnected portions. The effect achieved by the abovementioned refinement is a further reduction in noise since the engagement portion engaging in the engagement structure of the rotor, for example a clamping arm or an outer layer of a clamping arm, of the at least one engagement element is composed of a softer material.

In principle, of all of the components of the rotation damper according to the invention can be composed of a plastic. They can then be produced in a particularly simple manner by plastics injection molding. However, other materials for the components of the damper are also conceivable.

The invention also relates to a system consisting of a rotation damper according to the invention and a component which is coupled to the transmission element, preferably a component which is mounted movably in a vehicle. As explained, the component can be mounted, for example, pivotably in the interior of a vehicle, such as a passenger car or truck. For example, it can be a flap which is mounted pivotably in the interior of a vehicle, for example a glove compartment flap or the like.

### BRIEF DESCRIPTION OF THE DRAWINGS

An exemplary embodiment of the invention will be explained in more detail below with reference to figures, in which, schematically:

FIG. 1 shows a rotation damper according to the invention in a perspective exploded illustration,

FIG. 2 shows a partial top view of the rotation damper shown in FIG. 1 in the mounted state and in a first operating state, and

FIG. 3 shows the illustration from FIG. 2 in a second operating state.

Unless stated otherwise, the same reference signs in the figures denote identical objects.

### DETAILED DESCRIPTION

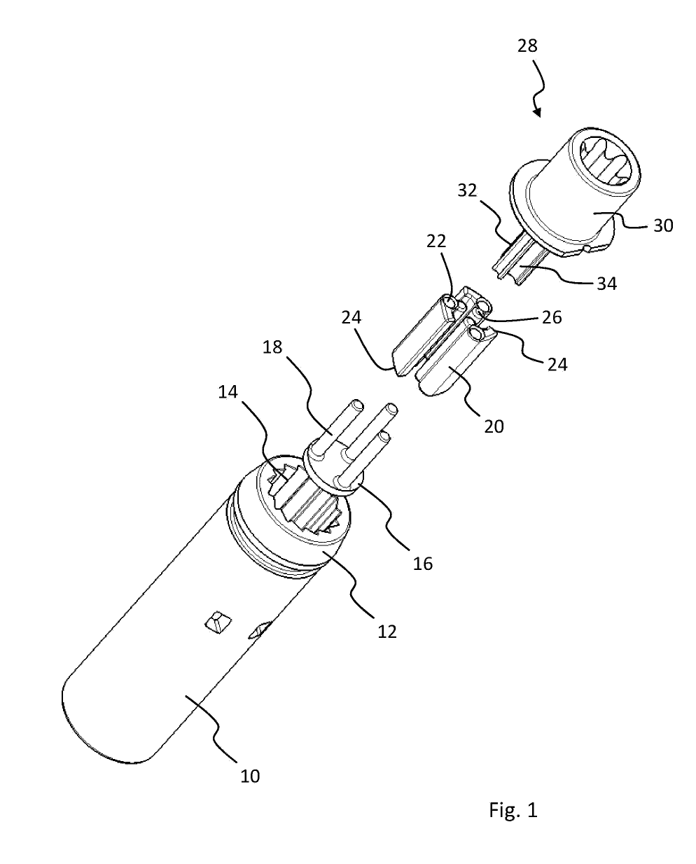

The rotation damper according to the invention that is shown in FIG. 1 has a housing 10 in which a rotor 12 is rotatably arranged. The housing 10 is filled with a viscous liquid, for example a silicone or oil, and therefore a rotational movement of the rotor 12 in the housing 10 leads to a braking action. An inner surface of the rotor 12 has an engagement structure 14 in the form of a plurality of clamping projections forming a toothing. Furthermore, the rotation damper comprises a support disk 16 which is rotatable in relation to the rotor 12 and on the upper side of which three rotary shafts 18 in the example shown are integrally formed. The rotary shafts 18 serve for the pivotable mounting of in each case one of three engagement elements 20. For this purpose, the engagement elements 20 each have a cylindrical receptacle 22 with which they are pushed onto the rotary shafts 18. The engagement elements 20 furthermore each have a clamping arm 24 and a circular coupling projection 26. The circular coupling projections 26 extend in the same manner as the engagement elements 20 with their clamping arms 24 overall in the direction of the longitudinal axis of the rotation damper, and therefore the circular coupling projections 26 each form the shape of a circular cylinder.

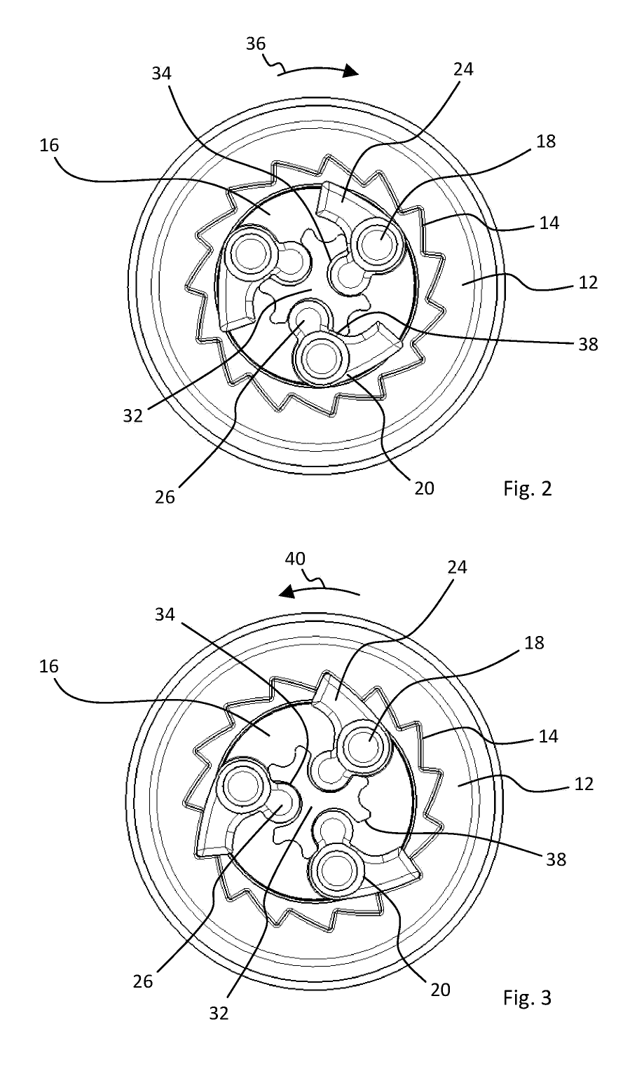

The rotation damper according to the invention furthermore comprises a transmission element 28 which has a head portion 30 with which said transmission element is couplable to a component to be damped in such a manner that the transmission element 28 is rotated during a movement of the component, for example a pivoting movement of the component, about its longitudinal axis which here also corresponds to the longitudinal axis of the housing 10 of the rotation damper. The head portion is not illustrated in FIGS. 2 and 3 for illustrative reasons. A transmission portion 32 of the transmission element 28 that, in the example shown, has three circular coupling receptacles 34 distributed uniformly over its circumference extends from the head portion 30. The coupling receptacles 34 form C-shaped circular receptacles for the coupling projections 26. The circular coupling receptacles 34 are each formed in a complementary manner to the coupling projections 26 of the engagement elements 20. In particular, the radius of the circular coupling receptacles 34 is substantially identical to the radius of the circular coupling projections 26. In the mounted state, as can be seen in FIGS. 2 and 3, the coupling projections 26 are thereby accommodated in the coupling receptacles 34 in a substantially play-free manner.

FIG. 2 illustrates the release position of the engagement elements 20. Said release position is taken up when the transmission element 28 is rotated (by the movement of the component), in the clockwise direction in FIG. 2, as illustrated by the arrow 36. On account of the engagement of the coupling projections 26 in the coupling receptacles 34 and the explained pivotable mounting of the engagement elements 20 on the support disk 16, said rotational movement leads to simultaneous rotation of the support disk 16 with the transmission element 28 and to pivoting of the engagement elements 20 in a direction of rotation opposed to the direction of rotation of the transmission element 28 and of the support disk 16, i.e. counterclockwise in FIG. 2, into the release position which is shown in FIG. 2 and in which the clamping arms 24 each strike against a stop surface 38 of the transmission portion 32 of the transmission element 28. As can be seen in FIG. 2, the clamping arms 24 here are pivoted into a radially inner position in which they are not in engagement with the engagement structure 14 of the rotor 12. The rotational movement of the transmission element 28 and of the support disk 16 is therefore not transmitted to the rotor 12. A rotation in freewheeling form without a braking action of the rotor 12 and therefore damping of the component movement is accordingly possible.

If the transmission element 28 is now rotated in the opposed direction of rotation, for example starting from the release position shown in FIG. 2, i.e. counterclockwise in FIG. 3, as illustrated by the arrow 40, on account of the rolling of the coupling projections 26 in the coupling receptacles 34 a pivoting movement of the engagement elements 20 in the opposed direction of rotation, i.e. in the clockwise direction in FIG. 3, immediately occurs, with the clamping arms 24 of the engagement elements 20 coming into force-fitting engagement with the engagement structure 14, in particular in each case with a clamping projection of the engagement structure 14. In said engagement position, a rotational movement of the transmission element 28 in the direction of rotation 40 is then transferred into a corresponding rotational movement of the rotor 12 in the stationary housing 10, in particular in the viscous liquid located therein. By this means, a braking action and therefore damping of the component movement occurs. If, starting from FIG. 3, the transmission element 28 is rotated back again in the direction indicated in FIG. 2 by the arrow 36, a correspondingly oppositely directed pivoting movement of the engagement elements 20 immediately occurs in turn until the release position shown in FIG. 2 is reached.

By means of the complementary design of the coupling projections 26 and of the coupling receptacles 34, the coupling projections 26 are accommodated in the coupling receptacles 34 in a manner substantially free from play. A production of noise is thereby likewise minimized as is a required torque in the freewheeling form. Complicated guide measures for the engagement elements 20 can likewise be omitted. As can be seen in particular in FIGS. 2 and 3, the coupling of the coupling projections 26 and of the coupling receptacles 34 acts similarly to a planetary gear, by means of which the rotational movement of the transmission element 28 is transferred into a corresponding pivoting movement of the engagement elements 20 in the opposed direction.

It should also be pointed out that in particular the clamping arms 24, on their outer surfaces coming into engagement with the engagement structure 14 in the engagement position shown in FIG. 3, can have a layer composed of a softer material than the rest of the material of the engagement elements 20. By this means, a further reduction in noise can be achieved.

### LIST OF REFERENCE SIGNS

10 Housing
12 Rotor
14 Engagement structure
16 Support disk
18 Rotary shaft
20 Engagement element
22 Cylindrical receptacle
24 Clamping arm
26 Coupling projection
28 Transmission element
30 Head portion
32 Transmission portion
34 Coupling receptacles
36 Arrow
38 Stop surface
40 Arrow

What is claimed is:

1. A rotation damper for damping the movement of a component, comprising a transmission element which is couplable to the component in such a manner that said transmission element is rotated during a movement of the component, and comprising a rotatingly mounted rotor and also braking means which brake a rotational movement of the rotor, furthermore comprising coupling means which couple the transmission element and the rotor for conjoint rotation in a first direction of rotation of the transmission element and decouple same in a second, opposite direction of rotation, wherein the coupling means comprise a support element on which at least one engagement element is mounted so as to be pivotable between an engagement position, in which the at least one engagement element is in engagement with an engagement structure of the rotor, the engagement structure being arranged radially on the outer side with respect to the at least one engagement element, and a release position, in which the at least one engagement element is not in engagement with the engagement structure of the rotor, wherein the at least one engagement element has at least one coupling portion, and wherein the transmission element has at least one coupling portion which is in engagement with the at least one coupling portion of the engagement element, wherein the coupling portions of the transmission element and of the at least one engagement element are formed in a complementary manner with respect to each other.

2. The rotation damper as claimed in claim 1, wherein the at least one coupling portion of the at least one engagement element is at least one circular coupling projection, and wherein the at least one coupling portion of the transmission element is at least one circular coupling receptacle which is complementary to the at least one circular coupling projection.

3. The rotation damper as claimed in claim 1, wherein the at least one engagement element has at least one clamping arm, the free end of which is in engagement with at least one clamping projection of the rotor in the engagement position.

4. The rotation damper as claimed in claim 1, wherein the at least one engagement element is in engagement in a force-fitting manner with the engagement structure of the rotor in the engagement position.

5. The rotation damper as claimed in claim 1, wherein at least three engagement elements are provided, and wherein the transmission element has at least three coupling portions.

6. The rotation damper as claimed in claim 5, wherein the transmission element has a transmission portion on the circumference of which the at least three coupling portions are formed, wherein the at least three engagement elements with their coupling portions are arranged distributed uniformly over the circumference of the transmission portion.

7. The rotation damper as claimed in claim 1, wherein the braking means comprise a housing which is filled with a viscous liquid and in which the rotor is rotatably arranged.

8. The rotation damper as claimed in claim 1, wherein the support element which pivotably supports the at least one engagement element is a support disk which is rotatable relative to the rotor.

9. The rotation damper as claimed in claim 8, wherein at least one rotary shaft for the rotatable mounting of the at least one engagement element is integrally formed on the support disk.

10. The rotation damper as claimed in claim 1, wherein the at least one engagement element has a basic portion composed of a first material and an engagement portion which is in engagement with the engagement structure of the rotor in the engagement position and is composed of a second material which is softer than the first material.

11. A system comprising a rotation damper as claimed in claim 1 and a component which is coupled to the transmission element and which is mounted movably in a vehicle.

12. A rotation damper for damping movement of a component, comprising:
a transmission element couplable to the component such that said transmission element is rotated during a movement of the component;
a rotatingly mounted rotor mounted for a rotational movement within a housing that includes a viscous fluid for braking the rotational movement;
a coupling element coupling the transmission element and the rotor for conjoint rotation in a first direction of rotation of the transmission element and decoupling the transmission element and the rotor in a second, opposite direction of rotation, wherein the coupling element includes a support element on which an engagement element is mounted so as to be pivotable between an engagement position, in which the engagement element is in engagement with an engagement structure of the rotor, the engagement structure being arranged radially outward of the engagement element, and a release position, in which the engagement element is not in engagement with the engagement structure of the rotor,
wherein the engagement element has a coupling portion, and
wherein the transmission element has a coupling portion in engagement with the coupling portion of the engagement element,
wherein the coupling portion of the transmission element and the coupling portion of the engagement element are formed in a complementary manner with respect to each other.

13. The rotation damper as claimed in claim 12, wherein the coupling portion of the engagement element includes a circular coupling projection, and wherein the coupling portion of the transmission element includes a circular coupling receptacle which is complementary to the circular coupling projection.

14. The rotation damper as claimed in claim 13, wherein the engagement element has at least one clamping arm with a free end that is in engagement with a clamping projection of the rotor when the engagement element is in the engagement position.

15. The rotation damper as claimed in claim 14, wherein the engagement element is in engagement in a force-fitting manner with the engagement structure of the rotor when the engagement element is in the engagement position.
